(19) United States
(12) Patent Application Publication
(10) Pub. No.: US 2008/0189592 A1
(43) Pub. Date: Aug. 7, 2008

(54) METHOD FOR DISPLAYING TEXT IN PORTABLE TERMINAL

(75) Inventors: Moon Heui LEE, Gumi-si (KR); Soon Jin KIM, Daegu Metropolitan City (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/935,013

(22) Filed: Nov. 5, 2007

(30) Foreign Application Priority Data
Feb. 7, 2007 (KR) 10-2007-0012475

(51) Int. Cl. G06F 17/21

(52) U.S. Cl. 715/204

(57) ABSTRACT

A method for displaying a text in a portable terminal includes setting a font, comparing a text with word forms stored in a database upon receiving a request to display the text, converting words in the text that match the stored word forms to the set font, and displaying a converted text containing the converted words.

### CROSS REFERENCE TO RELATED APPLICATION

This application claims priority from and the benefit of Korean Patent Application No. 10-2007-0012475, filed on Feb. 7, 2007, which is hereby incorporated by reference for all purposes as if fully set forth herein.

### BACKGROUND OF THE INVENTION

1. Field of the Invention

The present invention relates to a supplementary function of a portable terminal, and more particularly, to a method for displaying a text in a portable terminal that allows words in a text to be converted to a set font according to a predetermined condition.

2. Discussion of the Background

Portable terminals are widely used in a variety of applications due to their easy-to-carry design, storage and playback functions for various execution programs, and wide usage of embedded options. In particular, a short message service (SMS) function is one of the most widely used functions and enables a user to transmit and receive a desired message at low cost and/or when voice calling is not available. Another useful feature is an electronic book (e-book) function that converts a full text of a paper-made book into a digital format using HTML or XML for storage and viewing.

However, because the text provided by the aforementioned functions of a portable terminal may have a uniform size or color, it may be difficult for people having poor vision or color blindness to read the text.

### SUMMARY OF THE INVENTION

The present invention relates to a method for displaying a text in a portable terminal in which words in a text are converted to a set font according to a predetermined condition, thus enabling display of the words in a manner distinguishable from other words.

Additional features of the invention will be set forth in the description which follows, and in part will be apparent from the description, or may be learned by practice of the invention.

The present invention discloses a method for displaying a text in a portable terminal including setting a font, comparing a text with word forms stored in a database upon receiving a request to display the text, converting words in the text that match the stored word forms to the set font, and displaying a converted text containing the converted words.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic block diagram showing a configuration of a portable terminal that displays a text message according to an exemplary embodiment of the present invention.

FIG. 2 is a flowchart showing a method for setting a message conversion mode of a portable terminal according to an exemplary embodiment of the present invention.

FIG. 3A and FIG. 3B show examples of screens that are displayed during the method of FIG. 2.

FIG. 4 is a flowchart showing a method for displaying a text message in a portable terminal according to another exemplary embodiment of the present invention.

FIG. 5A, FIG. 5B, and FIG. 5C are show examples of screens that are displayed during the method of FIG. 4.

FIG. 6 is a flowchart showing the process of parsing a text message in the method of FIG. 4.

FIG. 7 is a flowchart showing a method for displaying a converted text message according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

While in the exemplary embodiments described, a method for displaying a text in a portable terminal is applied to a text message, the method may also be applied to any type of function that can display a text, such as an E-book, a schedule, or a notepad.

The text may be displayed in any language that can be divided into individual, distinguishable words. The term “word” refers to a unit that can be independently used in the text. A “word form” refers to the grammatical form of a word constituting a text, such as a subject, an object, a complement, an adverb, or an adjective. A method for converting a text according to exemplary embodiments of the present invention allows only words having a semantic meaning to be converted to a set font and does not allow words typically suffixed to other words such as particles, endings, and stems to be converted.

Further, in the exemplary embodiments below, the term “message conversion mode” refers to a mode in which a portable terminal changes the size, the thickness, and/or the color of words corresponding to the specific word form. The term “font setting” refers to the set size, thickness, and/or color of words that a user requests to change.

Although a portable terminal according to an exemplary embodiment of the present invention is configured to select words corresponding to a predetermined condition from a text and convert the words to a set font, the terminal may be any type of multimedia information and communication device including, for example a digital broadcasting terminal, a Personal Digital Assistant (PDA), a Smart Phone, an International Mobile Telecommunication 2000 (IMT-2000) terminal, a Code Division Multiple Access (CDMA) terminal, a Global System for Mobile communication (GSM) terminal, a Universal Mobile Telecommunication Service (UMTS) terminal, and applications thereof.

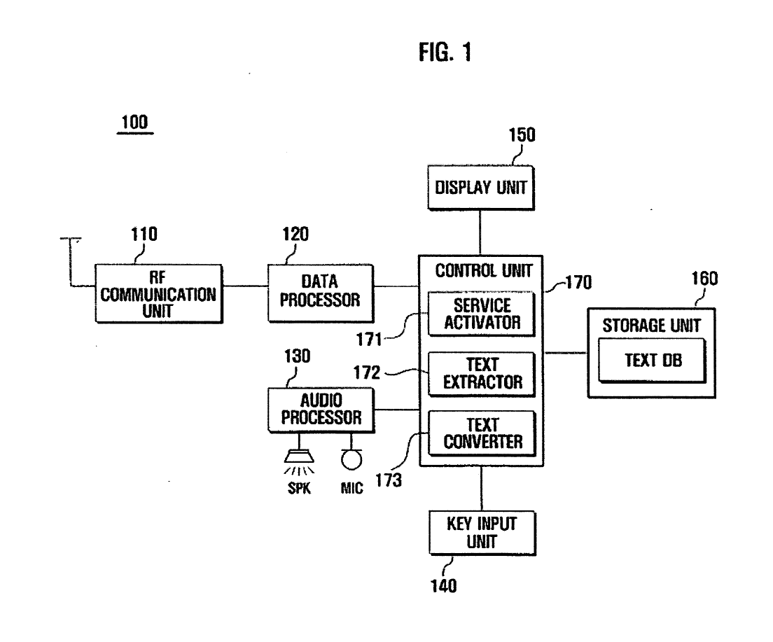

FIG. 1 is a schematic block diagram showing a configuration of a portable terminal 100 that displays a text message in a portable terminal according to an exemplary embodiment of the present invention.

Referring to FIG. 1, the portable terminal 100 includes a radio frequency (RF) communication unit 110, a data processor 120, an audio processor 130, a key input unit 140, a display unit 150, a storage unit 160, and a control unit 170.

The RF communication unit 110 establishes a communication channel between the portable terminal 100 and a base station for data communication and voice calling and transmits user data using the communication channel. The RF communication unit 110 also manages a series of calls related to transmission and reception of content and a control signal associated with the content. The RF communication unit 110 includes an RF transmitter to up-convert the frequency of a signal to be transmitted and amplify the signal and an RF receiver to low-noise amplify a received signal and down-convert its frequency. In particular, according to the present exemplary embodiment, the RF communication unit 110 may transmit or receive a short message or multimedia message to or from another portable terminal.

The data processor 120 processes audio data received from the audio processor 130, numeric/character data input by a user through the key input unit 140, and data received from the RF communication unit 110. The data processor 120 may include a transmitter to encode and modulate a signal to be transmitted through the RF communication unit 110 and a receiver to demodulate and decode the received signal. The data processor 120 may include a data codec to process incoming data such as packet data and an audio codec to process audio signals such as voice.

The audio processor 130 reproduces an audio signal received from the data processor 120 and outputs an audio signal, such as voice input through a microphone MIC, to the data processor 120. That is, the control unit 170 controls the audio processor 130 to convert audio data into audible sound and output the audible sound through a speaker SPK. The control unit 170 also controls the audio processor 130 to convert an audio signal, such as voice received via the microphone MIC, into data for output to the data processor 120.

The key input unit 140 receives numeric/character information that is input by the user and includes a plurality of input/function keys to set various functions. The function keys may include arrow keys, side keys, and shortcut keys that are set to perform specific functions. The key input unit 140 also outputs a key signal to the control unit 170 in response to input by the user to set and control the functions of the portable terminal 100.

The display unit 150 may display various menus of the portable terminal 100, user data input by the user, function setting information, and other information provided to the user. The display unit 150 may be a liquid crystal display (LCD). If the LCD is implemented using touch screen technology, the display unit 150 may be incorporated into an input portion. In particular, in the present exemplary embodiment, the display unit 150 displays an original text message and a text message obtained by converting the original text message using font information set by the user.

The storage unit 160 stores execution programs necessary to perform functions, downloaded content, user data generated by the user, and text messages. The storage unit 160 may include one or more buffers to temporarily store user data generated during the execution of an execution program, such as a text message execution program. The storage unit 160 may include a program area and a data area.

The program area stores an operating system to activate the portable terminal 100, execution programs necessary to perform a text message function, and other execution programs necessary to perform other options of the portable terminal 100, such as a camera function, an audio playback function, and an image/motion video playback function. When a function is activated upon user request, the control unit 170 of the portable terminal 100 performs the function using a stored execution program corresponding to the function.

The data area stores data generated during use of the portable terminal 100, such as content downloaded from a content server or other terminals, and user data related to various options, such as motion videos or images taken using the camera function, phone book data, audio data, text messages, and setting information corresponding to the user data. In particular, the data area may include a text database (DB) to store types of word forms set during manufacture of the portable terminal 100 as well as words, special characters, and numerals input by the user.

The control unit 170 controls the overall operation of the portable terminal 100, including signal flow between internal units of the portable terminal 100. The control unit 170 may also control the function of the data processor 120.

In particular, the control unit 170 controls functions related to the editing of a text message and includes a service activator 171, a text extractor 172, and a text converter 173.

If a text message is received from a content server or another portable terminal, the service activator 171 checks whether the user has set message conversion. For instance, the user may set message conversion before receiving a text message. The user may also decide whether to convert a text message through a pop-up window that may be displayed when the text message is received. If the user sets message conversion, the service activator 171 parses the received text message. Parsing refers to the translating of a text written in a computer language into a machine language using a compiler or interpreter as a language translator. The parsing step is performed to analyze the grammatical structure and syntax of each sentence and build an optimal parse tree for a given grammatical form.

That is, in the present exemplary embodiment, parsing refers to a process of analyzing the received text message into words. The service activator 171 parses the received text message into individual words and outputs the message words to the text extractor 172.

The text extractor 172 compares the message words received from the service activator 171 with word forms stored in the text DB. More specifically, the text extractor 172 compares the message words with word forms stored in the text DB and extracts words corresponding to specific word forms from the message words. The text extractor 172 also determines whether the extracted words match word forms that the user has requested be converted and outputs the words for conversion corresponding to the word forms to the text converter 173. Alternatively, in another exemplary embodiment, the text extractor 172 may extract all message words corresponding to the word forms stored in the text DB and output the extracted message words to the text converter 173.

The text converter 173 converts the matched message words received from the text extractor 172 according to a font set by the user. To this end, the text converter 173 changes at least one of a size, a thickness, and a color of the message words received from the text extractor 172 to distinguish them from other message words in the text message. However, the font is not limited to the size, the thickness, and the color of a word and may include a font style that can be changed to distinguish a message word desired by the user from other message words. That is, the text converter 173 may convert the matched message words to a font that was set during manufacture of the portable terminal 100 or to a font set by the user. The text converter 173 reorganizes the converted message words and the remaining words into a new text message. The control unit 179 then controls display unit 150 to display the resulting text message.

For convenience of explanation, FIG. 1 is a block diagram of the portable terminal 100, however the portable terminal 100 may have various configurations. For example, the portable terminal 100 according to exemplary embodiments of the present invention may further include a camera module and a digital broadcasting receiver depending on the type of application.

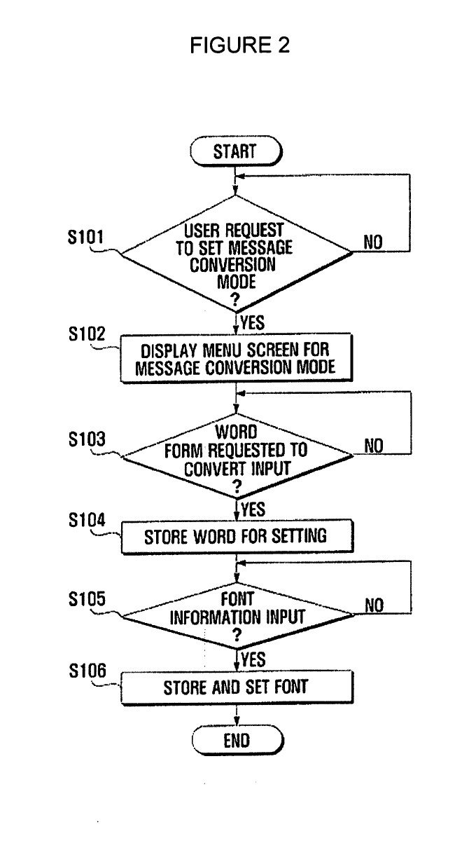

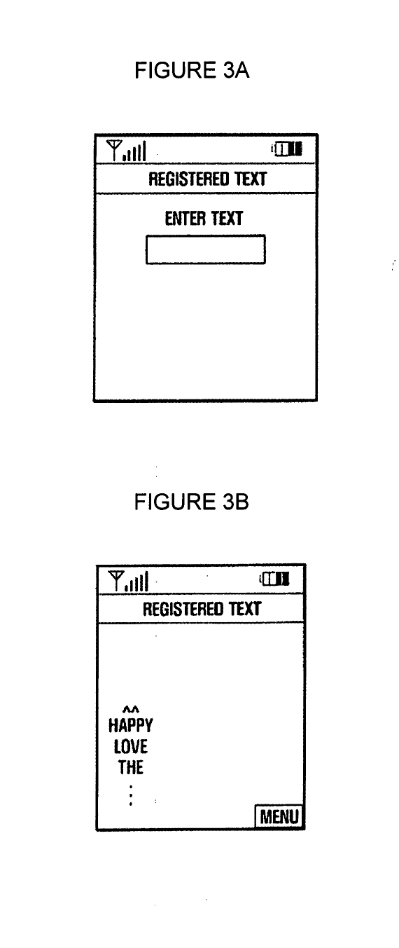

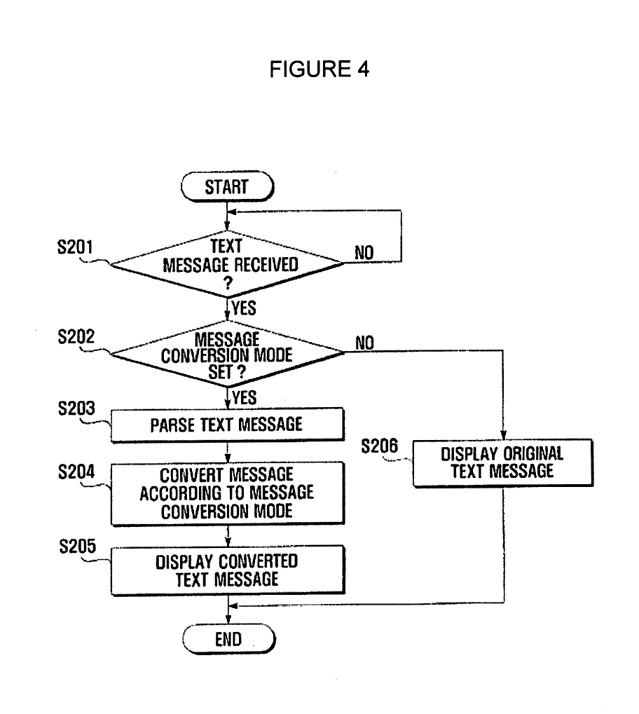

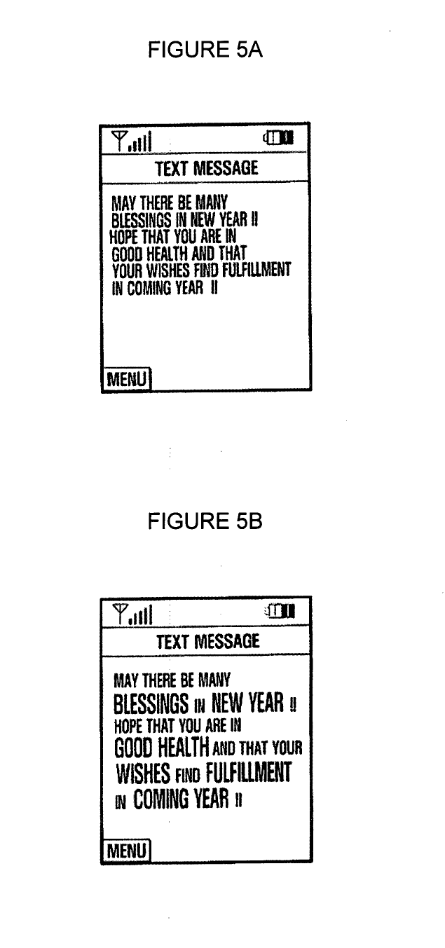

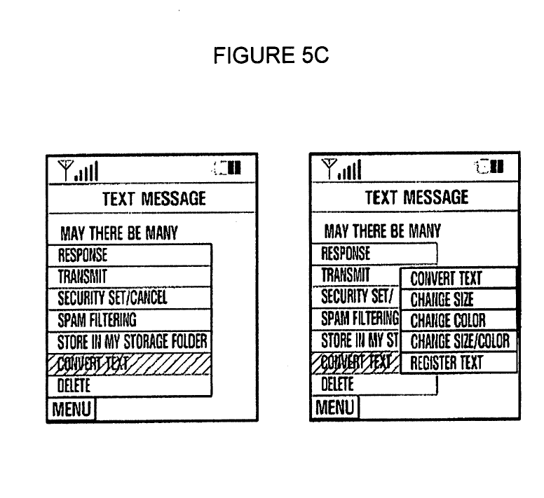

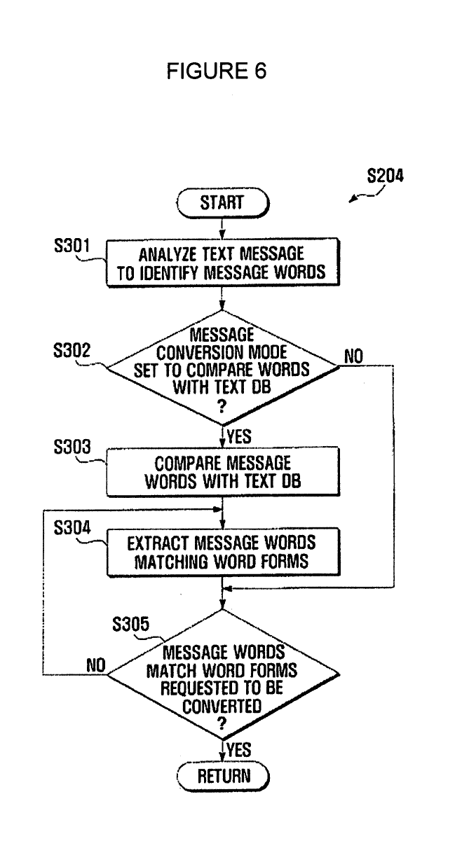

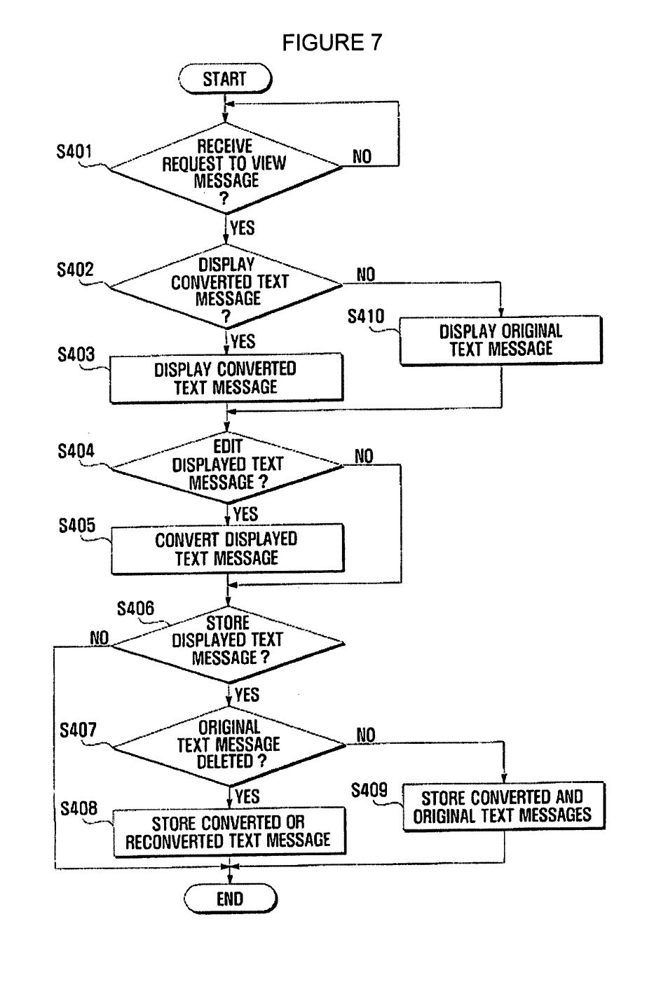

A method for displaying a text message in the portable terminal 100 having the above-mentioned configuration according to an exemplary embodiment of the present invention is described in detail with reference to FIG. 1, FIG. 2, FIG. 3A, FIG. 3B, FIG. 4, FIG. 5A, FIG. 5B, FIG. 5C, FIG. 6, and FIG. 7.

FIG. 2 is a flowchart showing a method for setting a message conversion mode of the portable terminal 100 according to an exemplary embodiment of the present invention. FIG. 3A and FIG. 3B show examples of screens display during the method of FIG. 2.

Referring to FIG. 1 and FIG. 2, upon receiving a request from a user to set a message conversion mode (S101), the control unit 170 controls the display unit 150 to display a menu screen for the message conversion mode (S102). The control unit 170 then checks whether a word form that has been selected to be converted is included in a received text message (S103). A word form is a grammatical form of a word. Thus, in order to easily read the received text message, the user may request conversion of words corresponding to nominative, predicative, objective, complementary, and adnominal cases that are the main grammatical elements contained in the text message.

If a word form that has been selected to be converted is included in the received text message at step S103, the control unit 170 controls the storage unit 160 to store the word form in a setting (S104). If font information is then input (S105), the control unit 170 controls the storage unit 160 to store the input font information in the setting (S106). The font information may include at least one of the size and the color of a word extracted corresponding to a word form that the user requested be converted. However, in setting a message conversion mode according to the present exemplary embodiment, font information may be set before a word form to be converted is input, instead of after a word form to be converted is input.

Alternatively, upon selection of a message conversion mode, words corresponding to word forms that are the main grammatical elements in a text message, i.e. subject, predicate, and object, may be extracted and converted into words with a specific color and size.

When the portable terminal 100 is in the message conversion mode, the user may also directly input a desired word to convert. For example, the user may directly enter the desired word into a displayed text input box, as shown in FIG. 3A or may view a list of words directly input by the user into the text DB, as shown in FIG. 3B.

FIG. 4 is a flowchart showing a method for displaying a text message in the portable terminal 100 according to another exemplary embodiment of the present invention. FIG. 5A, FIG. 5B, and FIG. 5C show examples of screens that are displayed during the method of FIG. 4.

Referring to FIG. 4, upon receiving a text message (S201), the control unit 170 checks whether a message conversion mode is set (S202). The message conversion mode refers to a mode in which the control unit 170 compares message words with word forms stored in the text DB to extract the message words that correspond to the word forms and checks whether the extracted message words match word forms selected by the user in order to convert the message words corresponding to the selected word forms to a set font.

If a message conversion mode is set, the control unit 170 parses the received text message (S203), converts the parsed text message according to a set message conversion mode (S204), and controls the display unit 150 to display a new text message (S205). More specifically, the control unit 170 parses the received text message to identify message words and compares the message words with word forms stored in the text DB to extract message words that match the word forms. The control unit 170 then checks whether the extracted message words match word forms selected by the user. If the extracted message words match the selected word forms, the control unit 170 then converts the matching message words to a set font. Thereafter, the control unit 170 reorganizes the converted message words and the remaining words into a new text message.

For example, upon receiving a text message in the portable terminal 100, as shown in FIG. 5A, the control unit 170 parses the received text message into words and compares the message words with word forms stored in the text DB. Referring to FIG. 5A, the message words are “new year,” “blessings,” “coming year,” “good health,” “wishes,” and “fulfillment.” If the message words correspond to word forms stored in the text DB exist, the control unit 170 extracts the message words. The control unit 170 checks whether the extracted message words match word forms selected by the user and converts the matching message words to a set font. If the font is set to change the size of matching message words, the control unit 170 changes the size of the matching message words corresponding to the word forms stored in the text DB and reorganizes the converted message words having the changed size and the remaining words into a new text message for display, as shown in FIG. 5B. As another example, if the set font requires that the color of matching message words be changed, the control unit 170 changes the color of the matching message words and reorganizes the converted message words having the changed color and the remaining words into a new text message for display. As another example, if the set font requires that the size and color of matching message words be changed, the control unit 170 changes the size and color of the matching message words and reorganizes the converted message words having the changed size and color and the remaining words into a new text message for display.

Returning to FIG. 4, if a message conversion mode is not set at step S202, the control unit 170 controls the display unit 150 to display the originally received text message (S206). When the original text message is displayed, the user may use a menu key to set a message conversion mode so that the control unit 170 can perform message conversion, as shown in FIG. 5C.

FIG. 6 is a flowchart showing step S203 of parsing a text message in the method of FIG. 4.

Referring to FIG. 1 and FIG. 6, if a message conversion mode is set when a text message is received, the control unit 170 analyzes the text of the received message to identify message words constituting the text message (S301). The control unit 170 then determines whether the message conversion mode is set such that the control unit 170 compares the message words with word forms stored in the text DB (S302). If the message conversion mode is set to compare the message words with stored word forms, the control unit 170 compares the message words with the word forms stored in the text DB (S303) and extracts message words corresponding to the word forms stored in the text DB from the message words (S304). The control unit 170 then checks whether the extracted message words match word forms that the user has requested be converted, such as subjective, predicative, objective, and complementary cases (S305). If the extracted message words match word forms selected by the user, the process continues at step S204 of FIG. 4 and the control unit 170 converts the matching message words according to the set message conversion mode.

If the message conversion mode is not set such that the control unit 170 compares the message words with word forms stored in the text DB at step S302, the control unit 170 checks whether the message words identified at step S301 match word forms that the user requested be converted at step S305.

FIG. 7 is a flowchart showing a method for displaying a converted text message according to another exemplary embodiment of the present invention.

Referring to FIG. 1 and FIG. 7, upon receiving a request from a user to view a message (S401), the control unit 170 checks whether the user requests to view a converted text message (S402). In this case, the control unit 170 selects whether to view the original text message or a converted text message by displaying a pop-up window.

If the user requests to view a converted text message, the control unit 170 controls the display unit 150 to display the converted text message (S403). If the user does not request to view a converted text message at step S402, the control unit 170 controls the display unit 150 to display the original text message (S410). The control unit 170 then checks whether it is set to edit the displayed text message (S404).

If the displayed text message is to be edited at step S404, the control unit 170 converts the displayed text message according to a condition selected by the user and displays the converted text message (S405). The text message is converted according to the method for converting a text message described above with reference to FIG. 4 and FIG. 6 and hence, a detailed explanation thereof will not be given. If the user requests that the displayed text message be stored (S406), the control unit 170 determines whether the original text message has been deleted (S407). If the original text message has been deleted, the control unit 170 controls the storage unit 160 to store the displayed text message (S408). The method for displaying a text message according to the present exemplary embodiment may further include a step of selectively storing a converted text message according to the user's selection.

If the original text message was not deleted at step S407, the control unit 170 controls the storage unit 160 to store the converted and original text messages (S409).

As described above, a method for displaying a text in a portable terminal according to exemplary embodiments of the present invention allows words in a text that correspond to a predetermined condition to be converted to a set font, thus enabling display of the words in a manner distinguishable from that of other words.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for displaying a text in a portable terminal, comprising:
setting a font;
comparing a text with word forms stored in a database upon receiving a request to display the text;
converting words in the text that match the stored word forms to the set font; and
displaying a converted text containing the converted words.

2. The method of claim 1, wherein setting a font comprises:
storing word forms input by a user;
setting at least one of a size, a thickness, and a color corresponding to the word forms.

3. The method of claim 2, further comprising:
parsing the text and extracting words from the text upon receipt of a request to display a text.

4. The method of claim 3, further comprising determining whether to convert the text before parsing the text.

5. The method of claim 4, further comprising displaying a pop-up window for the user to select whether to convert the text.

6. The method of claim 5, further comprising displaying an original text if the text is not to be converted.

7. The method of claim 4, further comprising determining whether the extracted words match word forms set by the user for conversion.

8. The method of claim 7, wherein the word forms are classified according to grammatical word forms.

9. The method of claim 8, wherein displaying a text comprises:
reconverting the displayed converted text; and
storing the reconverted text.

10. The method of claim 9, wherein the database comprises word forms classified according to grammatical word forms.

11. The method of claim 9, wherein the database comprises words, special characters, and numerals directly input by the user.
